(19) United States
(12) Patent Application Publication
(10) Pub. No.: US 2015/0065220 A1
(43) Pub. Date: Mar. 5, 2015

(54) METHODS AND SYSTEMS FOR PROVIDING REAL-TIME COACHING FOR ONLINE GAMING

(71) Applicant: Tarik Mustapha Nabi, Arlington, VA (US)

(72) Inventor: Tarik Mustapha Nabi, Arlington, VA (US)

(21) Appl. No.: 14/018,620

(22) Filed: Sep. 5, 2013

(51) Int. Cl. G07F 17/32

(52) U.S. Cl. CPC G07F 17/323; G07F 17/3293
USPC 463/13; 463/42; 463/31

(57) ABSTRACT

As a player has played a game sequence or is in the process of playing a game sequence of an online game such as poker, in which the player has either won or lost the hand, the player may elect to view a coaching or advice video, or to listen to an coaching audio recording, geared towards the specific type of hand or game sequence in which the player is involved. Accordingly, the player may learn from the coaching video or coaching audio as the player is playing the hand, in real time, or after the player has played the hand, to improve the player's proficiency in the game.

### BACKGROUND OF THE INVENTION

1. Field of Invention

Aspects of the present invention relate to methods and systems for enabling an online player to improve their play at an online casino game by providing the online player with real time video coaching. More particularly, aspects of the current invention related to methods and systems for providing an online game player with real time coaching via video or audio.

2. Description of Related Art

Many people enjoy playing poker, whether in a live setting such as a poker room or a casino, or online via a computer, but generally lack the skill to play and win in a consistent manner. There may be a number of reasons for the lack of consistent profit from playing a game such as, for example, poker. For example, some people are uncomfortable in a crowded and noisy casino, the air may be smoke-filled, fellow players may be drinking heavily and space at gaming tables may be rare. In addition, online players may also find it difficult to consistently win because a game such as poker requires a wide range of knowledge and experience, and an online player may be distracted by, for example, browsing the Internet, watching TV, or other such activity. For example, U.S. Patent Application Publication No. 2007/0155460 to Burnside et al., which is incorporated herein by reference in its entirety, teaches a network-based gaming system that enables a plurality of players to play poker online. Also, U.S. Patent Application Publication No. 2008/0280663 to Shar et al., which is also incorporated herein by reference in its entirety, teaches a method and system for allowing a plurality of users to compete against one another via a network in a poker game. Accordingly, a “real life” poker experience can be provided to a player, who can play poker for real money or for play money. It is to be noted that in general, players who regularly educate themselves by reading or that benefit from coaching from better players or from other sources fare better than players who do not benefit from coaching resources.

Although there is a very large variety of poker playing books, videos, seminars and other poker-playing teaching materials available to a poker player to improve the player's game, there is often a gap between the material that a player may be reading and the way that the player is playing on any given day based on a variety of parameters such as, for example, the player's state of mind, the player's bankroll, the player's particular circumstance and/or the player's competition.

There are many types of poker games that can be played online, over a network or on the Internet. When a player plays poker or any other game online, the player is often isolated and does not receive any constructive feedback during play. Accordingly, as a player is playing poker online from, for example, the player's home, the player is isolated and may be at a disadvantage when playing against more knowledgeable or experienced players. In addition, the player may be using non-standard, weak or unsound strategies when playing poker. As such, there is a distinct possibility that the player may lose money playing poker without the benefit of the advice of more knowledgeable players or of coaching resources.

It should be noted that although the above description relates to poker playing, aspects of the methods and systems according to this invention can be applied to any other online game which requires strategy. As such, mahjong, dominos, backgammon, chess, and any other game that requires strategy, are encompassed by the scope of aspects of this invention.

For many games, there are a large number of playing manuals, coaching resources in the form of books, audio recordings or video recordings. For example, for the game of poker, there is a wealth of coaching and advice material in the form of books, TV shows and videos providing poker training to the novice as well as the experienced player. Various poker manuals provide a large variety of resources on how to play specific poker hands for a large number of possible hand permutations. Such manuals may include “Doyle Brunson's Super System: A course in power poker” (Doyle Brunson; 1978); “Harrington on Hold'em: Expert Strategy for No-Limit Tournaments” (Daniel Harrington; 2007) and “Phil Hellmuth's Texas Hold'em” (Phil Hellmuth Jr.; 2003). Websites such as www.cardrunners.com, www.cardplayer.com and a number of other websites provide poker training to the novice as well as the experienced player. However, a large number of players suffer from an “execution gap,” which may be a situation where the player, during a given game, either lacks the necessary knowledge or does not correctly apply the knowledge that the player may already have about the game to an actual real life game situation because the player may be nervous, tired, worried about losing more money, or other such distracting factors.

### SUMMARY

In light of the above described problems and unmet needs, there is a need in the art for methods and systems to provide an individual playing an online game such as, for example, a poker game, with real time coaching videos or audios that are adapted to the specific hands in which the player is currently involved or has been involved.

According to various aspects, as a player has just finished playing a hand, or as a player is in the process of playing a hand, in which the player has either won or lost the hand, the player may elect to view a coaching or advice video or audio that provides coaching to the player. It should be noted that the coaching advice is advice that is related to the specific hand or situation that has just ended, or that is still in play, and for which the player seeks coaching. For example, if the game is Holdem poker, and the hand is a pair of nines losing to a straight, the coaching video may specifically treat the problem of playing a medium pair, or a pair of nines on a drawing board. Accordingly, the player may learn from the coaching video or audio, immediately after the hand has been played, or while the hand is being played, in real time, whether the player has played the hand correctly or incorrectly and how to play the hand correctly in the future.

According to various aspects, when a given hand has been played and the player has either won or lost the hand, or while the given hand is being played, a tab, pop-up window, other icon or signal such as a visual or audio signal, may be presented to the player, providing the player with the opportunity to view a coaching video or audio. If the player agrees to view the coaching audio or video, then the audio or video is presented to the player. If the player selects a coaching video, then a video is displayed to the player. Conversely, if the player refuses to view the video or audio, then no audio or video is provided to the player.

### BRIEF DESCRIPTION OF THE DRAWINGS

Various example aspects of the systems and methods will be described in detail, with reference to the following figures, wherein:

FIG. 1 is a flow chart illustrating a method of providing an online game player with a coaching video, according to various aspects of the current invention;

FIG. 2 illustrates a gaming network, in accordance with various aspects of the current invention;

FIG. 3 illustrates a gaming system, in accordance with various aspects of the current invention;

FIGS. 4(A)-4(B) are illustrations of an example interface for providing an online game player with a coaching video, according to various aspects of the current invention;

FIG. 5 presents an example system diagram of various hardware components and other features, for use in accordance with aspects of the present invention; and

FIG. 6 is a block diagram of various example system components, for use in accordance with aspects of the present invention.

### DETAILED DESCRIPTION

These and other features and advantages of this invention are described in, or are apparent from, the following detailed description of various exemplary aspects.

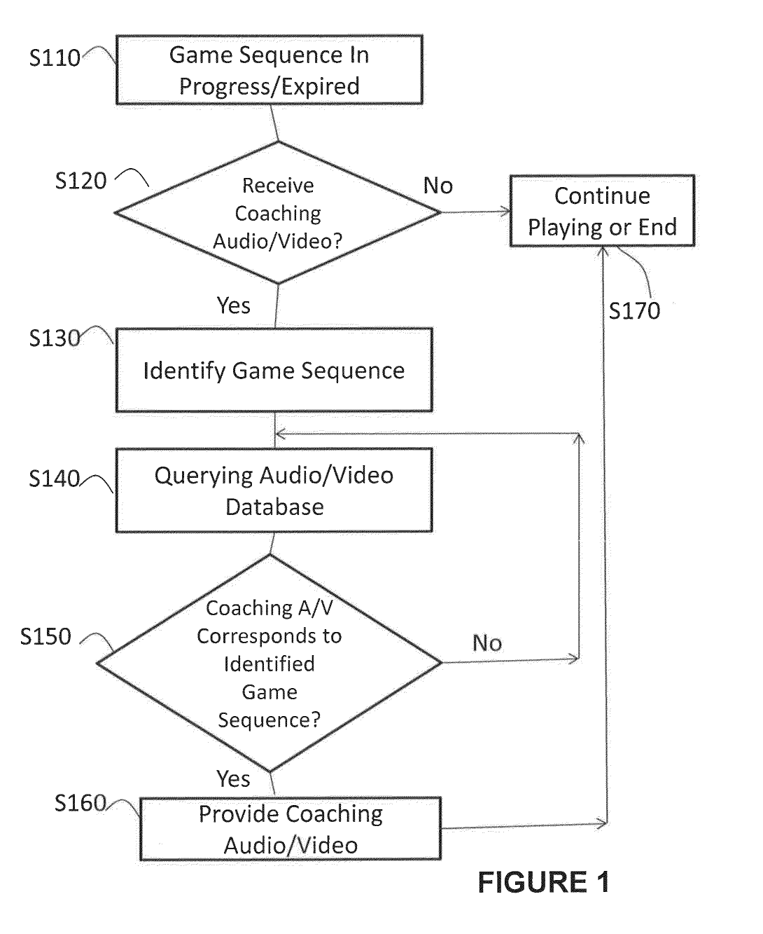

FIG. 1 is a flow chart illustrating a method of providing an online game player with a coaching video. According to various aspects of the current invention, the method starts in S110, where an online game player has just finished a hand, game portion or sequence. According to various aspects, the hand may still be in progress and has not yet ended at S110. In S120, the player is asked whether to view a coaching video or listen to a coaching audio recording. If the player agrees to watch the coaching video or listen to the coaching audio recording at S120, then the method proceeds to S130, where the latest game sequence or hand in which the player was involved at S110 is identified. Once the latest game sequence or hand is identified at S130, whether the game sequence has expired or is still ongoing, then a database of coaching videos or coaching audio recordings is queried at S140. According to various aspects, the database of coaching videos or coaching audio recordings is a database that includes a plurality of coaching videos or coaching audio recordings designed to provide advice or coaching tailored to a plurality of specific game sequences or hands of the game currently being played by the player, or of hand previously played by the player.

For example, if the game sequence is having a pair of Aces pre-flop in a no-limit Texas Holden game, then a coaching video or coaching audio recording may be a video and/or audio recording advising the player to raise two or three times the latest bet from another player. If the player sequence is having three-of-a-kind lose to a straight on the river, the coaching video and/or audio recording may be about adjusting bet sizing to prevent another player from drawing to the straight. Accordingly, the coaching videos and/or audio recordings may be specifically tailored to a relevant or selected hand or game sequence that has ended or that is still ongoing. It should be noted that several coaching videos and/or audio recordings may be available to address each specific possible playing situation. For example, for the same hand held by a player (e.g., a pair of nines pre-flop), the situation where no other player has raised before the player has to act is different from the situation where one player has raised before the player has to act, and is also different from the situation where one player has raised and another has re-raised before the player has to act, and so on. As such, one or more coaching videos and/or audio recordings may be available for each one of these specific situations. According to various aspects, each of these specific situations may have one or more designated coaching or advice videos and/or audio recordings available to the player.

According to various aspects, after the coaching video and/or audio recording database is queried at S140, one or more coaching or advice videos and/or audio recordings may be selected at S150. According to various aspects, the one or more coaching videos and/or audio recordings are selected because they are tailored to the same or a similar type of hand that has just ended or that is still ongoing. According to various aspects, the one or more coaching videos and/or audio recordings are selected because they provide advice on hands or game sequence that are identical, similar, or comparable to the type of hand or game sequence that has ended or that is still ongoing. As discussed above, if the hand that just ended is a three-of-a-kind that lost to a straight on the river, the coaching videos and/or audio recordings available to the player may be about adjusting bet sizing to prevent another player from drawing to the straight for this kind of hand but not about raising pre-flop with a pair of queens because the latter situation is irrelevant to the live game sequence that has just ended or that is still ongoing.

According to various aspects, once the one or more coaching or advice videos and/or audio recordings are selected at S150, then the player may view/listen to the one or more coaching or advice videos and/or audio recordings at S160. According to various aspects, the player may select an interface portion, such as a graphical user interface, on the screen, and the coaching or advice video, or a plurality of coaching or advice videos, may be displayed to the user at S160. Accordingly, the player may receive real-time on-the-spot coaching geared towards the specific situation to which the player is confronted. Such a real-time coaching may help the player maximize their ability to learn and play the game. When the player has viewed the coaching or advice video and/or audio recording, or while the player is viewing the coaching or advice video and/or audio recording, the player may elect to continue playing the game or leave the game at S170. Alternatively, if at S120 the player does not agree to watch/listen to the coaching video and/or audio recording, then the coaching video and/or audio recording is not provided to the player at S170 and the game may proceed or end.

According to various aspects, although the hands or game sequences that are discussed above are hands or game sequences that are ongoing or that have just ended, other hands or game sequences may be the subject of coaching video or audio, the other hands or game sequences having been played prior to the time at which the coaching is being sought by the player such as, for example, one or more hands or game sequences prior to the time at which the coaching is being sought by the player, or one or more playing sessions prior to the time at which the coaching is being sought by the player. As such, the player may select any hand or game sequence that the player has participated in, or any hand that took place at the player's table without the player participating in the hand, or any hand that took place while the player was not at the table, and receive coaching advice about the hand or game sequence. Because online gaming platforms generally number the hands or game sequences that are played by all the players, a player may select any hand by entering the hand or game sequence number and then receive coaching tailored specifically to that hand, even if the player did not participate in the hand.

It should be noted that although coaching videos are discussed in the steps above, a coaching audio recordings may also be proposed to the players instead of the coaching video.

According to various aspects of the current invention, in order to provide the player with a relevant coaching video and/or audio recording, the selected is compared to a database of coaching videos and/or coaching audio recordings. According to various aspects, the database of coaching videos and/or coaching audio recordings may be populated by correlating each hand possibility, or game sequence permutation, to a coaching video and/or a coaching audio recording. For example, if a No-Limit Texas Holdem hand ends with the user or player losing to a flush when there was a flush draw on the flop, then the correlated coaching video may be a video explaining that the player should have bet a higher amount to discourage the holder of the flush draw from having correct odds to draw to the flush. Thus, after each hand has concluded, the player may have the opportunity to view ch a coaching video to improve the player's understanding of and skill at the game. According to various aspects, the coaching video may be available to any of the players at the table, only to the wining player, or only to the losing player.

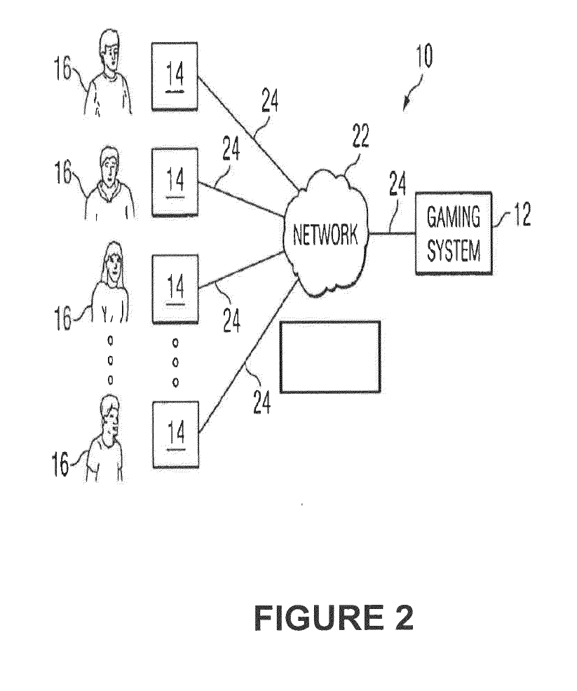

FIG. 2 is illustrates a gaming network 10, in accordance with a particular embodiment. The gaming network 10 may include a gaming system 12 and a plurality of access elements 14 through which players 16 may access the gaming system 12 and play the game. According to various aspects, the gaming system 12 may be coupled to access elements 14 through a communication network 22, which may allow the gaming system 12 and the access elements 14 to communicate with each other through a plurality of communication links 24. In particular embodiments, the gaming system 12 may be provided and maintained by a gaming company or organization, and the access elements 14 may permit users to access the gaming system 12 through the communication network 22.

According to various aspects, the gaming system 12 may provides one or more of a plurality of games for play by the users 16 accessing the gaming system 12 through the access elements 14. In particular embodiments, these games may include electronic poker games such as Hold 'Em, Omaha, Omaha Hi-Low, Seven Card Stud and Seven Card Stud Hi-Low. The gaming system 12 may also provide other games, including Pal Gow, bridge, Mah Jong, casino games such as Blackjack, and other games. The users 16 may play games provided through the gaming system 12 for free, for money or for various other prizes, such as coupons, discounts and merchandise. In some games, a user or player 16 may bet or wager real money, points or other items with or without monetary value. In the case of wagering and playing for money, the user 16 may deposit money in an account with the gaming system 12 by check, credit card, wire transfer or any other method. Once money is in a player's account with the gaming system 12, the player 16 may purchase electronic or virtual “chips” to be used in a game.

In the illustrated embodiment, the communication network 22 may enable communication between the access elements 14 and the gaming system 12, all of which may be distributed across multiple cities and geographic regions. The network 22 may include one or more or partial wide area networks (WANs), public switched telephone networks (PSTNs), local area networks (LANs), the Internet or any other communications and data exchange networks or systems that enable communication between communication system elements, including public or private wireline or wireless networks. For example, in particular embodiments, some access elements 14 may communicate with gaming system 12 over the Internet, while other access elements 14 may communicate with gaming system 12 over a LAN. The network 22 may also include any of a number of network components to enable communication between elements as described herein. Such network components may include gate keepers, call managers, routers, hubs, switches, gateways, endpoints or other hardware, software or embedded logic implementing any number of communication protocols that allow for the exchange of data in the gaming network 10. The term “communication network” should be interpreted as generally defining any network capable of transmitting audio and/or video telecommunication signals, data and/or messages. Generally, communication network 22 provides for the communication of packets, cells, frames, or other portions or data or information between and among gaming system 12 and access elements 14. In particular embodiments, the communication network 22 employs communication protocols that allow for the addressing or identification of access elements, nodes and/or systems coupled to network 22. For example, using Internet protocol (IP), each of the components coupled together by communication network 22 may be identified using IP addresses. In this manner, communication network 22 may support any form and/or combination of point-to-point, multicast, unicast or other techniques for exchanging media data and information among components of gaming network 10. Any network components capable of exchanging audio, video or other data using frames, packets or otherwise may be included within the scope of particular embodiments.

According to various aspects, the access elements 14 may each be associated with one or more users of gaming system 12. Access elements 14 may include any combination of hardware, software and/or encoded logic that provides communication services to a user. For example, the access elements 14 may include a telephone, a computer unning telephony software, a video monitor, a personal computer, a camera, an IP phone, a cell phone, a personal digital assistant (PDA) or any other communication hardware, software and/or encoded logic that supports the communication of data or information with gaming system 12 through communication network 22. The access elements 12 may also include unattended or automated systems, gateways, other intermediate components or other devices that can establish media sessions. In particular embodiments, the gaming system 12 provides a website that makes information and programming stored at gaming system 12 available to the access elements 14. The access elements 14 may access gaming system information, files and functionality using a Uniform Resource Locator (URL) of the website. The website may include web pages that may include text, images, sounds, animations and other information. In particular embodiments, the access elements 14 may operate software to act as an interface between users 16 and gaming system 12. In some cases this software may generally be referred to as “thin” or “dumb” software in situations where management and control of various games resides in the gaming system 12.

According to various aspects, the communication links 24 connecting the access elements 14 and the gaming system 12 to the network 22 may include any type of communication links capable of supporting data transfer, such as wireline or wireless links. In particular embodiments, the communication links 24 may include, alone or in combination, cable links, Digital Subscriber Line (DSL) links, Integrated Services Digital Network (ISDN) links, Asymmetric Digital Subscriber Line (ADSL) links, T1 or T3 communication lines, wireless communication links, hardware lines, telephone links or other suitable types of data communication links. The communication links 24 may also connect to a plurality of intermediate servers or other components between communication network 22 and gaming system 12 and between communication network 22 and access elements 14.

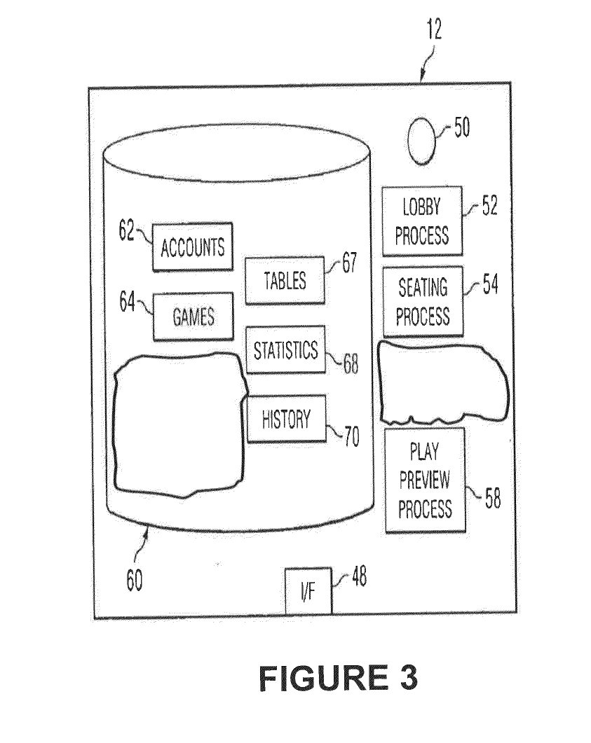

FIG. 3 illustrates a gaming system, in accordance with various aspects of the current invention. The gaming system 12 may include an interface 48, a processor 50, a lobby processor 52, a seating processor 54, a play review processor 58 and a memory 60. Particular embodiments may include a gaming system having none of the components above, some or all of the same or similar components as those described herein to perform various functionality described herein. The interface 48 couples the gaming system 12 with the communication network 22 and is operable to receive communications from and transmit communications to the communication network 22. The processor 50 may be a microprocessor, controller, or any other suitable computing device, resource, or combination of hardware, software and/or encoded logic operable to provide, either alone or in conjunction with other components of the gaming system 12 and the functionality of the gaming system 12. Such functionality may include controlling, managing and providing various features discussed herein to a plurality of users, such as users of access elements 14 accessing the gaming system.

According to various aspects, the memory module 60 may be any form of volatile or non-volatile memory including, without limitation, magnetic media, optical media, random access memory (RAM), read-only memory (ROM), removable media, or any other suitable local or remote memory component. The memory module 60 may store any suitable data or information, including software and encoded logic, utilized by the gaming system 12. In the illustrated embodiment, the memory module 60 includes accounts 62, games 64, tables 67, statistics 68 and history 70. Gaming systems in other embodiments may include memory that includes some, none or all of the same or similar components as those described with respect to memory module 60. Accounts 62 may include information relating to various players who have an account with the gaming system 12. Such information may include, for example, a player's history of play, account balance (e.g., in terms of money, chips, points or otherwise), profile, current play information such as whether the player is at a table or waiting for a spot at a table to open, or whether the player is playing at a cash table or at a tournament table, or any other suitable information. Games 64 generally include information associated with games that may be provided through gaming system 12. Such information may include, for example, gaming software, rules, options, procedures, configurations and other information associated with games provided. Tables 67 may generally include information associated with various tables of various games. For example, such information may include number of tables, current players at tables, game status information of tables, table betting parameters and any other suitable information to provide the functionality described herein.

According to various aspects, statistics 68 may include statistical information kept by gaming system 2, such as game statistics, player statistics, situational statistics related to games and/or players in various situations and any other suitable statistical information. Statistics 68 may keep detailed player statistics that help define a player's skill level, such as statistics regarding a player's aggressiveness, folding percentage and raise percentage. History 70 may include historical information associated with gaming system 12, such as game history, player history, recorded games and recorded hands or situations. According to various aspects, the lobby process 52, the seating process 54, and the play review process 58 may comprise suitable hardware, software or encoded logic processes, algorithms or methods executed by the gaming system 12, for example in conjunction with processor 50. Gaming systems in other embodiments may provide similar or different processes to execute some or all of the functionality described herein. Various functionality of the gaming system 12 that may be provided in one or more embodiments is described herein. This functionality may be provided in any of a number of suitable games, such as various poker games and bridge.

In particular embodiments, a user 16 may log-in to the gaming system 12 by keying in a unique login name, which may ultimately be displayed at the user's selected seat at a poker table. In some embodiments, when a player indicates he wishes to play a particular game for the very first time, the lobby processor 52 may create a player record in accounts 62. After the user has successfully logged in, he/she is generally presented with an option to choose the type of game he/she wishes to play, and the player may be connected to the software of the chosen game which displays game information at the user's access element 14. This information may be a summary listing the number of tables and players involved in that particular game or, under a typical online format, a list of active tables, some of which may have open seats. In some embodiments, new players may be able to view a table screen before deciding whether to play in that particular type of game. When a player is presented with the table screen, the screen may display other players 16 who may be accessing the gaming system 12 through other access elements 14 from, for example, different geographic locations. In some cases, each player may be identified by their respective login name. There may be an image of a stationary dealer at the table who deals but does not play.

As a particular hand of play begins, the cards may be dealt electronically. A randomizing algorithm may be used to shuffle the cards, so the play may be faster than a normal manual game in which the cards must be physically shuffled. In some embodiments, an active player 16 may view or see his cards on a screen of his access element 14, and each player 16 may act on his/her hand in clockwise order or in any other order. A player may immediately decide, based on his hand of cards dealt to him, whether to continue play, It is not typical for all players playing a given dealt hand to stay to the end of the hand until a winner is determined. If, at a point of time after the hand is dealt, a player determines that his/her hand is insufficient to warrant playing further, he/she can exercise an option to not play and fold his/her hand.

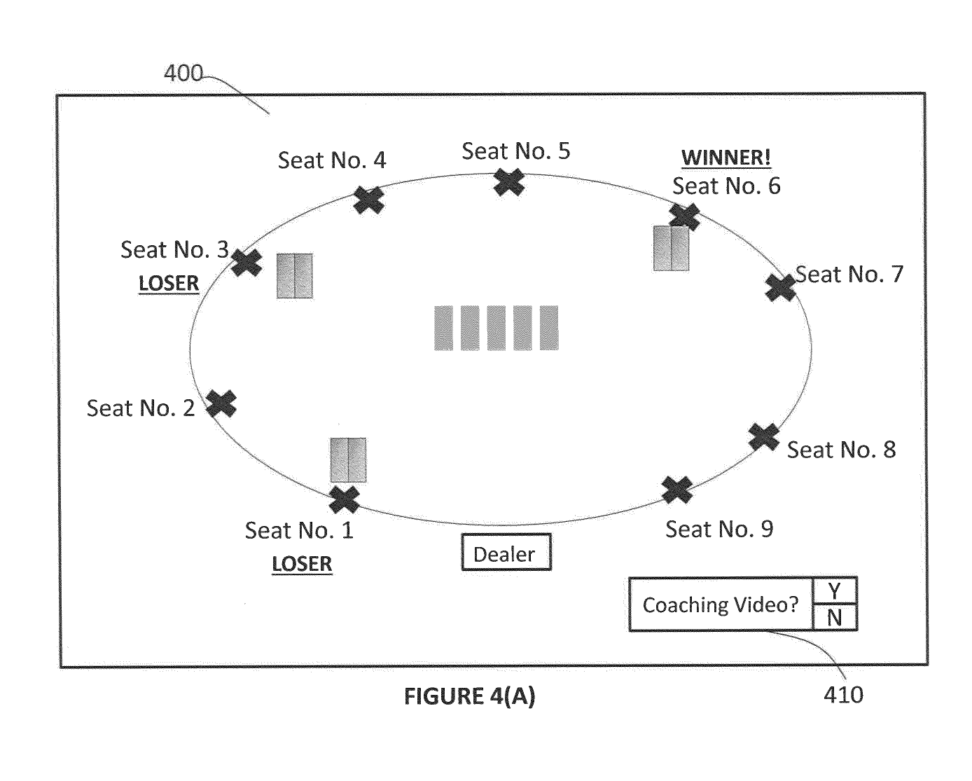

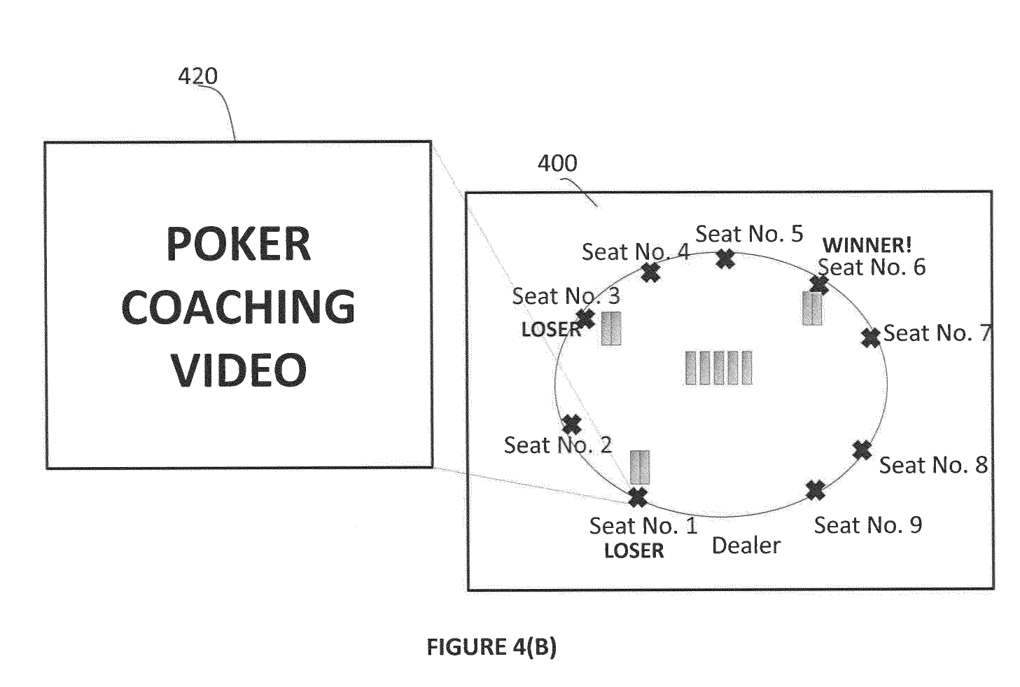

FIGS. 4(A)-4(B) are illustrations of an example interface for providing an online game player with a coaching video, according to various aspects of the current invention. In FIG. 4(A), the display screen 400 of, for example, a computer of one of the players, illustrates the situation during a live online poker game where a hand has ended, and there is a single winner (seat 6) and two losers (seats 1 and 3). According to various aspects, an icon 410 may appear on a portion of the display screen of the winner, of one of the losers, of all of the losers, or of any player at the table, and the player can elect to view a coaching video by clicking on the icon 410 and select “Yes.” If the player selects “No,” then no coaching video is displayed and the player can continue playing the game or leave the game. According to various aspects, whether a coaching video is displayed to a player or not, the game continues without interruption, According to other aspects, the game stops during play of the coaching video.

According to various aspects, if a player selects “Yes” at the icon 410, then a coaching video 420 is launched on at least a portion of the screen 400, as illustrated in FIG. 4(B). For example, the coaching video may be displayed on the entire screen 400, or on a portion of the screen 400 to allow the player who selected the video to continue playing the game. According to various aspects, the type of coaching video to be presented to a player may be chosen based on the last hand that has been played, or based on any hand selected by the player. For example, if the player has lost with a flopped straight to a flush on the river, then a coaching video that specifically deals with this hand, or with this type of hand, or with betting size on the flop to prevent another player from catching up with a bigger hand, may be provided to the player. Accordingly, the player may be provided with a coaching video that is specifically tailored to the latest hand that the player was involved in, or to a selected hand, so that the player can benefit from live (i.e., during a player's playing session) coaching that deals directly with a situation in which the player is involved.

According to various aspects, in order to accomplish the above goal of providing a player with a coaching video that corresponds to the player's immediate hand, or immediate playing experience, or a player selected hand, a database of coaching videos may be provided. The coaching videos may be stored in a data repository and classified under a variety of topics. According to various aspects, coaching videos may be available for various categories such as “starting hands,” “pre-flop raising,” “post-flop raising,” “power of position,” “semi-bluffing,” “playing a draw,” “protecting a made hand,” “reacting to a check-raise,” “double barreling” on the turn; “triple barreling on the river,” “playing two pair on the flop”, “playing a set with a draw on the flop,” and other categories covering every possible hand situation in poker, or covering a large number of possible hand situations in poker. As such, a database of coaching videos may be prepared that correspond to most or all possible situations to which a player may be confronted. As such, a coaching session addressing substantially every specific situation in which a player is involved may be provided. Thus, when the player has just ended a hand and desires to view a coaching video about the hand that just ended, or about another hand that the player can select, the selected hand is recognized, for example, as one of the categories described above. Once the selected hand is recognized, the database of coaching resources, such as coaching videos and/or coaching audio recordings, is searched to select an appropriate coaching video or audio, which may be a video that deals with that same type of as the selected hand. Once the appropriate coaching video is selected, then the coaching video may be presented to the player. According to various aspects, another player that was not directly involved in the hand such as, for example, the player at Seat No. 8 on FIG. 4(B), may also have the possibility of viewing a coaching video relative to the latest hand, or to any other selected hand.

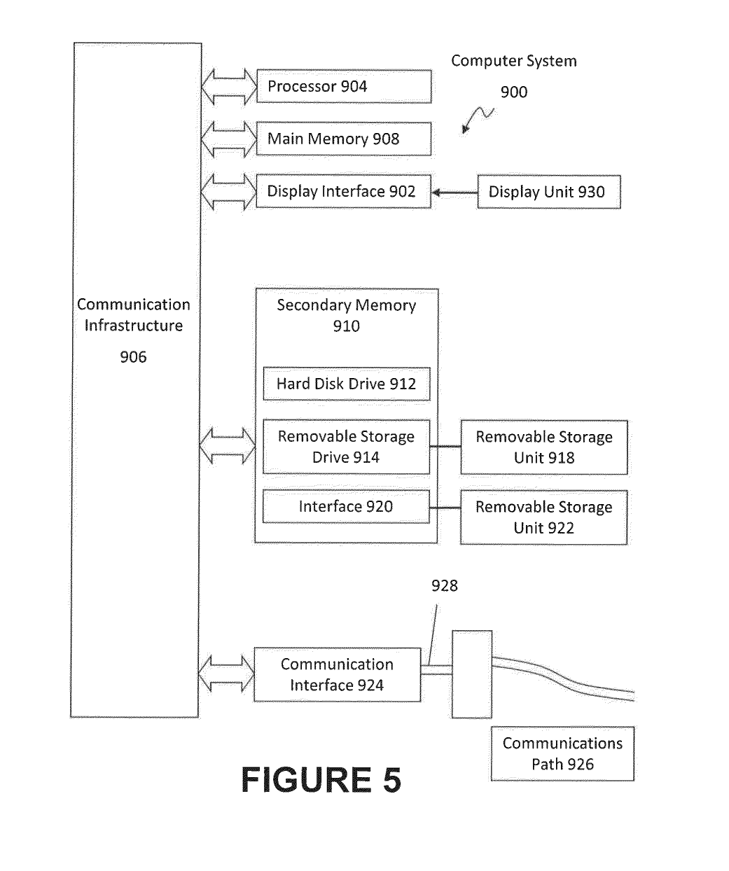

In some variations, aspects of the present invention may be directed toward one or more computer systems capable of carrying out the functionality described herein. An example of such a computer system 900 is shown in FIG. 5.

Computer system 900 includes one or more processors, such as processor 904. The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 914, a hard disk installed in hard disk drive 912, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an aspect where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

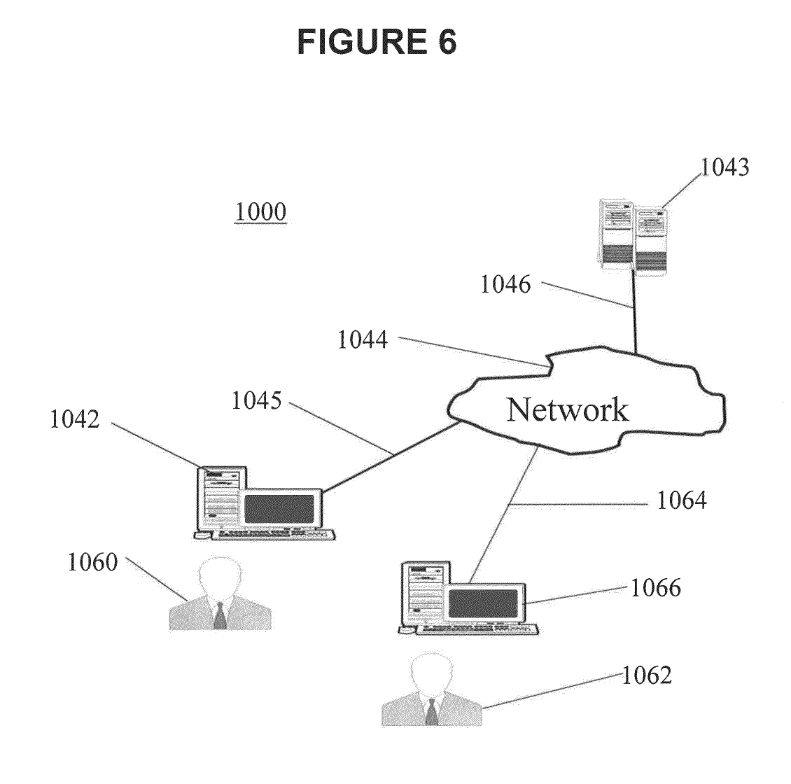

FIG. 6 shows a communication system1000 involving use of various features in accordance with aspects of the present invention. The communication system 1000 includes one or more assessors 1060, 1062 (also referred to interchangeably herein as one or more “users”) and one or more terminals 1042, 1066 accessible by the one or more accessors 1060, 1062. In one aspect, operations in accordance with aspects of the present invention is, for example, input and/or accessed by an accessor 1060 via terminal 1042, such as personal computers (PCs), minicomputers, mainframe computers, microcomputers, telephonic devices, or wireless devices, such as personal digital assistants (“PDAs”) or a hand-held wireless devices coupled to a remote device 1043, such as a server, PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1064 include, for example, wired, wireless, or fiberoptic links. In another aspect, the method and system of the present invention operate in a stand-alone environment, such as on a single terminal.

While this invention has been described in conjunction with the example aspects outlined above and further described in Attachment A), various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A computer-implemented method of providing coaching material to one or more of a plurality of online game players during live play of a game, the computer having a processor and a data repository, the method comprising:
storing in the data repository a plurality of game coaching resources;
determining via the processor a relevant game sequence;
querying one or more of the online game players about receiving coaching material relative to the relevant game sequence;
selecting one or more of the coaching resources; and
providing the selected one or more coaching resources to the one or more of the online game players based on a response to the query.

2. The method of claim 1, wherein determining the relevant game sequence comprises one of:
selecting a game sequence that has ended; and
selecting a game sequence that is in progress.

3. The method of claim 1, wherein each of the plurality of game coaching resources stored in the data repository is correlated to at least one game sequence.

4. The method of claim 1, wherein the plurality of coaching resources comprise at least one of one or more coaching videos and one or more coaching audio recordings.

5. The method of claim 1, wherein selecting the one or more of the coaching resources comprises:
identifying the relevant game sequence; and
querying the data repository to select one or more relevant coaching resources that are related to the relevant game sequence.

6. The method of claim 5, wherein the one or more relevant coaching resources comprise coaching resources that are related to a game sequence that is at least one of identical, similar and comparable to the relevant game sequence.

7. The method of claim 1, wherein the relevant game sequence is a hand of Poker.

8. The method of claim 1, wherein querying the one or more of the online game players comprises querying at least one of one or more of the online players that have won the game sequence, one or more of the online players that have lost the game sequence, and one or more of the online players that are not participating in the relevant game sequence.

9. A system for providing coaching material to one or more of a plurality of online game players during live play of a game, the system comprising:
means for storing a plurality of game coaching resources;
means for determining a relevant game sequence;
means for querying one or more of the online game players about receiving coaching material relative to the relevant game sequence;
means for selecting one or more of the coaching resources; and
means for providing the selected one or more coaching resources to the one or more of the online game players based on a response to the query.

10. A system for providing coaching material to one or more of a plurality of online game players during live play of a game, the system comprising:
a processor;
a user interface functioning via the processor; and
a data repository accessible by the processor; wherein a plurality of game coaching resources is stored in the data repository;
a relevant game sequence is determined;
one or more of the online game players are queried about receiving the coaching material relative to the relevant game sequence;
one or more of the coaching resources are selected; and
the selected one or more coaching resources are provided to the one or more of the online game players based on a response to the query.

11. The system of claim 10, wherein the relevant game sequence comprises one of:
a game sequence that has ended; and
a game sequence that is in progress.

12. The system of claim 10, wherein each of the plurality of game coaching resources stored in the data repository is correlated to at least one game sequence.

13. The system of claim 10, wherein
the relevant game sequence is identified; and
the data repository is queried to select one or more relevant coaching resources that are related to the relevant game sequence.

14. The system of claim 13, wherein the one or more relevant coaching resources comprise coaching resources that are related to a game sequence that is at least one of identical, similar and comparable to the relevant game sequence.

15. The system of claim 10, wherein at least one of:
the processor is housed on at least one of a terminal and a server, the at least one of the terminal and the server being selected from a group consisting of a personal computer, a minicomputer, a main frame computer, a microcomputer, a hand held device, a telephonic device, a local storage device and a remote storage device;
the server is coupled to a network that comprises at least one of the Internet and an intranet; and
the data repository is housed on at least one of the terminal and the server.

16. The system of claim 15, wherein the server is coupled to the network via a coupling selected from a group consisting of a wired connection, a wireless connection, and a fiberoptic connection.

17. The system of claim 9, wherein the means for selecting the one or more of the coaching resources comprises:
means for identifying the relevant game sequence; and
means for querying the data repository to select one or more relevant coaching resources that are related to the game sequence.

18. The system of claim 10, wherein the plurality of coaching resources comprise at least one of one or more coaching videos and one or more coaching audio recordings.

19. The system of claim 10, wherein the game sequence is a hand of poker.

20. The system of claim 10, wherein at least one of one or more of the online players that have won the game sequence, one or more of the online players that have lost the game sequence, and one or more of the online players that are not participating in the relevant game sequence are queried about receiving the coaching material.
